(19) United States
(12) Patent Application Publication
(10) Pub. No.: US 2022/0126530 A1
(43) Pub. Date: Apr. 28, 2022

(54) METHOD OF MANUFACTURING MOLDED PRODUCT

(71) Applicant: Honda Motor Co., Ltd., Tokyo (JP)

(72) Inventor: Naoto ISHII, Tokyo (JP)

(73) Assignee: Honda Motor Co., Ltd., Tokyo (JP)

(21) Appl. No.: 17/469,910

(22) Filed: Sep. 9, 2021

(30) Foreign Application Priority Data
Oct. 28, 2020 (JP) 2020-180601

(51) Int. Cl. B29C 70/34; B29C 70/12; B29C 70/54

(52) U.S. Cl. CPC B29C 70/342; B29L 2031/771; B29C 70/544; B29C 70/12

(57) ABSTRACT

A method of manufacturing a foam molded product having a reinforcement layer including a short fiber provided on a surface layer. The method includes the following steps. In a fiber layer formation step, the short fiber is adhered to and deposited on a cavity surface of a mold to form a fiber layer. In a covering step, a silicone rubber sheet is arranged on the mold to cover the fiber layer. In a compression step, air is sucked between the silicone rubber sheet and the cavity surface to compress the fiber layer by the silicone rubber sheet and the cavity surface. In a molding preparation step, the silicone rubber sheet is removed from the fiber layer after compression, a foam material is suppled into a cavity of the mold, and the mold is clamped. In a molding step, the foam material in the cavity is foamed and cured.

### CROSS-REFERENCE TO RELATED APPLICATION

This application claims the priority benefit of Japan application serial no. 2020-180601, filed on Oct. 28, 2020. The entirety of the above-mentioned patent application is hereby incorporated by reference herein and made a part of this specification.

### BACKGROUND

### Technical Field

The disclosure relates to a method of manufacturing a molded product.

### Description of Related Art

Conventionally, to reinforce the back surface of a molded product, there is a technique in which an adhesive is applied to a mold surface (cavity surface) and a reinforcing material formed of a fiber is adhered to the adhesive by static electricity to form a reinforcement layer by this reinforcing material, and then, a resin material is injected (see, for example, Patent Document 1: Japanese Patent Application Laid-Open No. 57-102329). Further, in blow molding, there is a technique in which an insulating layer on the mold surface is charged, a fiber material is charged with electric charge enabling adsorption to the charged layer, and the fiber sheet is adsorbed to the mold surface to form a reinforcement layer (see, for example, Patent Document 2: Japanese Patent Application Laid-Open No. 2017-87584).

However, the technique described in Patent Document 1 has an issue that a step of applying an adhesive is required to surely adhere the fiber to the mold surface, and a step of cleaning the mold surface is required after mold release. Further, the technique described in Patent Document 2 has an issue that a step of charging the mold surface and a device for this purpose are required. That is, there is room for improvement in terms of speeding up the process and the like associated with the adhesion of the reinforcing material to the mold surface.

### SUMMARY

According to an embodiment, the disclosure recited in claim 1 provides a method of manufacturing a molded product (e.g., a foam molded product W of the embodiment) having a reinforcement layer (e.g., a reinforcement layer WB of the embodiment) including a reinforcing material (e.g., a short fiber F1 of the embodiment) provided on a surface layer. The method includes the following steps. In a material layer formation step, the reinforcing material is adhered to and deposited on a cavity surface (e.g., a cavity surface 4b of the embodiment) of a mold (e.g., a mold 2 of the embodiment) to form a material layer (e.g., a fiber layer F2 of the embodiment). In a covering step, a covering material (e.g., a silicone rubber sheet 18 of the embodiment) is arranged on the mold to cover the material layer. In a compression step, air is sucked between the covering material and the cavity surface to compress the material layer by the covering material and the cavity surface. In a molding preparation step, the covering material is removed from the material layer after compression, a molding material is supplied into a cavity (e.g., a cavity 2C of the embodiment) of the mold, and the mold is clamped. In a molding step, the molding material is cured in the cavity to obtain the molded product. According to this configuration, by compressing the material layer formed on the cavity surface with the covering material, the strength of the material layer can be improved. Accordingly, it is possible to prevent the reinforcing material from partially falling off and to facilitate uniformity of the material density and the thickness of the material layer. In addition, since the compressed material layer makes it difficult for the molding material to reach the cavity surface, it is easier to release the molded product, and the molded product can be efficiently manufactured. Further, the reinforcement layer is provided at a portion in contact with other parts such as a seat frame, and if the molding material exudes to the reinforcement layer, the molded body may come into contact with other parts and abnormal noise may be generated. In contrast, by making the material density and the thickness of the material layer uniform, it is possible to suppress generation of abnormal noise.

In the disclosure recited in claim 2, the method includes a charging step of charging the reinforcing material before or at the same time as the material layer formation step. The material layer formation step is a step of adhering and depositing the charged reinforcing material onto a non-metal portion on the cavity surface. In the covering step, the material layer is covered with the covering material composed of an insulator. According to this configuration, by adhering the charged reinforcing material to the non-metal portion of the cavity surface, the material layer can be easily formed by utilizing static electricity. Further, by charging the reinforcing material and using the charged reinforcing material, it is possible to eliminate the need for large-scale equipment and steps such as one for applying a high voltage to a conductive fiber using a high voltage power supply to charge the fiber. Further, since an insulator is used as the covering material that covers the material layer and the fiber is not made conductive, it is possible to suppress removal of the static electricity of the reinforcing material and collapse of the material layer.

In the disclosure recited in claim 3, the cavity surface has air permeability allowing air to pass, and in the material layer formation step, by sucking air at the cavity surface, the reinforcing material is adsorbed to the cavity surface. According to this configuration, by adsorbing the reinforcing material while performing air suction at the cavity surface, the material layer on the cavity surface can be formed more quickly, and the molded product can be manufactured more efficiently.

In the disclosure recited in claim 4, in the covering step, by sucking air at the cavity surface, the reinforcing material is adsorbed to the cavity surface. According to this configuration, it is possible to prevent the reinforcing material from falling off from the cavity surface up to the time when the material layer is compressed by the covering material. Accordingly, the material density and the thickness of the material layer can be made uniform.

In the disclosure recited in claim 5, in the compression step, by sucking air at the cavity surface, the material layer is compressed by the covering material and the cavity surface. According to this configuration, the material layer can be compressed by the covering material while the material layer is adsorbed to the cavity surface. Accordingly, the molded product can be manufactured more efficiently.

In the disclosure recited in claim 6, the material layer formation step is a step of blowing out the reinforcing material from a nozzle (e.g., a nozzle 10 of the embodiment) to form the material layer on the cavity surface. The method includes, before the material layer formation step, a cover attachment step of covering the cavity surface with a cover member (e.g., a cover member 14 of the embodiment) by leaving a blowout space facing an outlet of the nozzle. According to this configuration, the material layer is formed by spraying the reinforcing material from the nozzle onto the cavity surface, so that the material layer can be formed quickly and efficiently. Further, by covering the cavity surface with the cover member by leaving a blowout space facing the outlet of the nozzle, in the subsequent material layer formation step, even if a part of the reinforcing material does not adhere to the cavity surface, it is possible to prevent the reinforcing material from scattering around the mold.

In the disclosure recited in claim 7, in the material layer formation step, the reinforcing material floating in the blowout space is sucked by a suction means (e.g., a suction device 16 of the embodiment). According to this configuration, by sucking and removing the excessive reinforcing material floating in the cover member, the uniformity of the material layer can be improved. Further, the excessive reinforcing material that does not adhere to the cavity surface may be recovered and reused, so that the material cost can be suppressed and the economic efficiency can be improved.

In the disclosure recited in claim 8, a region covered with the cover member is provided with a storage means (e.g., a storage part 14a of the embodiment) storing the covering material in a manner capable of taking the covering material in and out. According to this configuration, after the material layer formation step, the material layer can be covered with the covering material without removing the cover member. Therefore, as compared with the case where the covering material is arranged after removing the cover member after the material layer formation step, it is possible to quickly perform the steps from the formation of the material layer to the compression of the material layer. Accordingly, the molded product can be manufactured more efficiently.

### BRIEF DESCRIPTION OF THE DRAWINGS

FIG. 1 is a perspective view of a vehicle seat according to an embodiment of the disclosure.

FIG. 2 is a cross-sectional view taken along line II-II of FIG. 1.

FIG. 3 is a view viewed from arrow III of FIG. 2.

FIG. 4 is a cross-sectional view schematically showing FIG. 2.

FIG. 5 is a view viewed from arrow V of FIG. 4.

FIG. 6 is an enlarged view showing an application example of a main part of FIG. 4.

FIG. 7 is an enlarged view showing a second application example of the main part of FIG. 4.

FIG. 8 is a view showing an application example of FIG. 5.

FIG. 9 is a front view showing an example of application to a seat back of the seat.

FIG. 10 is a cross-sectional view taken along line Xs-Xs of FIG. 9.

FIG. 11 is a cross-sectional view showing an application example of FIG. 10.

FIG. 12 is a cross-sectional view corresponding to FIG. 10 showing another example of application to the seat back of the seat.

FIG. 13 is view showing a spread state of a mold of a molding apparatus according to the embodiment of the disclosure.

FIG. 14 is a view showing a first example of the molding apparatus.

FIG. 15 is a view showing a second example of the molding apparatus.

FIG. 16 is a view showing a covering material to be attached to the mold of the molding apparatus.

FIG. 17 is a view showing a mold clamping state of the mold of the molding apparatus.

### DESCRIPTION OF THE EMBODIMENTS

According to the disclosure, a molded product can be efficiently produced in a method of manufacturing a molded product in which a reinforcing material is adhered to a mold surface to obtain a reinforcement layer.

Hereinafter, embodiments of the disclosure will be described with reference to the drawings.

### <Foam Molded Product>

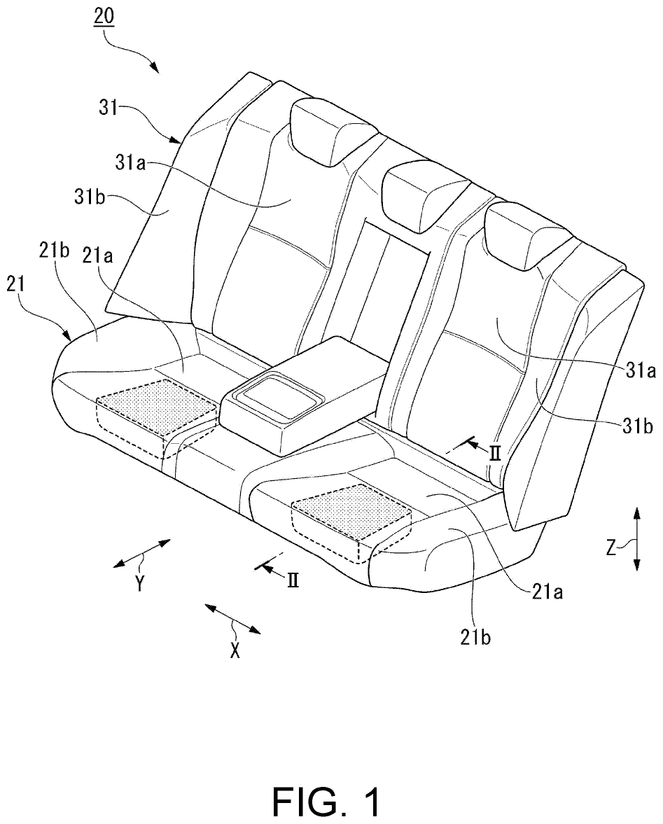

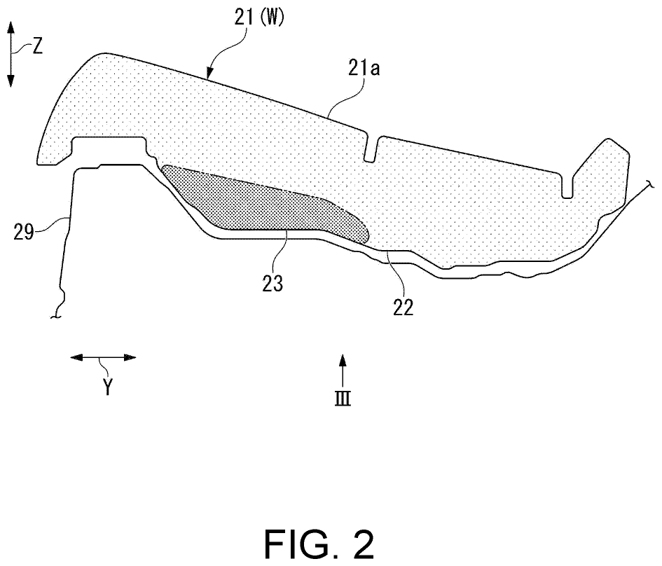

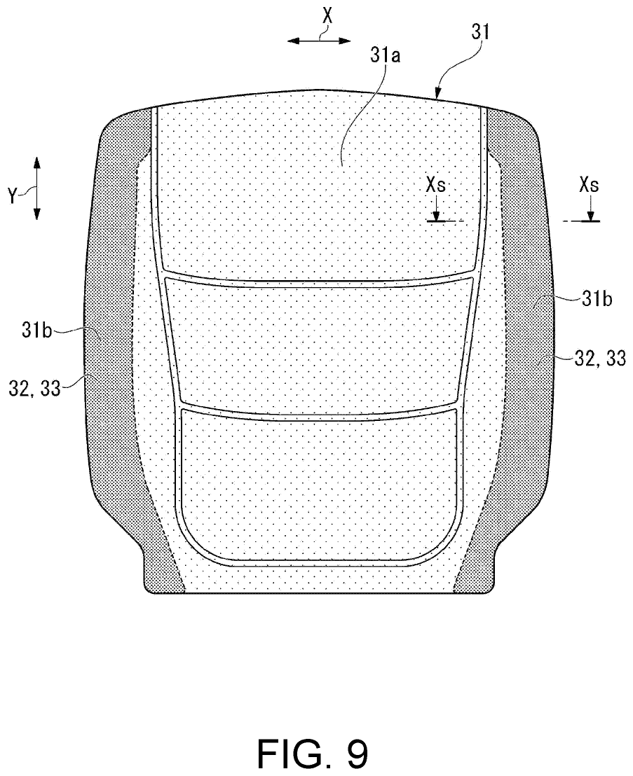

As shown in FIG. 1 and FIG. 2, a foam molded product W (which may be hereinafter simply referred to as a “molded product W”) of the embodiment is applied to a cushion member of a seat cushion 21 on which an occupant sits in a vehicle seat 20. In the figures, arrow X indicates the left-right direction, arrow Y indicates the front-rear direction, and arrow Z indicates the vertical direction, as viewed when the molded product W is mounted on a vehicle as the configuration of the seat cushion 21. Hereinafter, the molded product W will be described based on the orientations indicated by arrows X, Y, and Z. In FIG. 2, numeral 29 indicates a vehicle body that supports the seat cushion 21. In some cases, the molded product W is also applied to a cushion member of a seat back 31 that supports the back of the occupant in the vehicle seat 20 (see FIG. 9 to FIG. 12). An example of the latter will be described later.

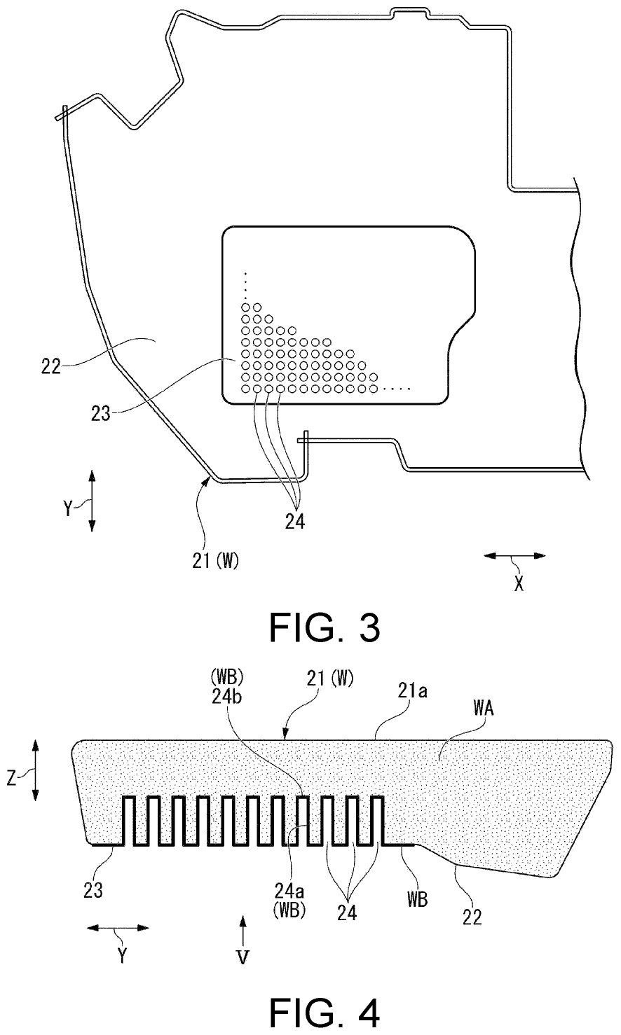

Refer to FIG. 3 to FIG. 5 together, in the molded product W, a reinforcement range 23 with a urethane impregnated cured layer (reinforcement layer) WB is set on an exterior surface 22 along a back surface (lower surface) of the seat cushion 21. The reinforcement range 23 is provided at a position which overlaps with a laterally central portion of a front portion of a seating position (seating surface; upper surface) 21a in the seat cushion 21 as viewed in the vertical direction.

A plurality of recesses 24 that are recessed upward from the exterior surface 22 toward the inside (seating surface 21a side) of the molded product W are formed in the reinforcement range 23. The recess 24 is formed in the shape of a bottomed round hole. In the reinforcement range 23, the reinforcement layer (urethane impregnated cured layer) WB is formed not only on the surface layer along a specified range of the exterior surface 22 but also on the surface layer along the inner surface of each recess 24.

The reinforcement range 23 is provided in a rectangular range along the exterior surface 22, and also has a predetermined width (thickness or height) in a direction (thickness direction of the seat cushion 21; vertical direction) substantially orthogonal to the exterior surface 22. In other words, the reinforcement range 23 is set as a three-dimensional range.

The reinforcement range 23 of the embodiment is provided to suppress the so-called submarine phenomenon. That is, to address the submarine phenomenon in which the occupant's body moves toward the vehicle front side while sinking into the seat cushion 21 at the time of a vehicle front collision, the reinforcement range 23 of the embodiment is provided so as to contribute to reception of a body movement load of the occupant.

When viewing the seating position 21a of the seat cushion 21 in the vertical direction, the reinforcement range 23 is set to a rectangular shape having a predetermined width in each of the depth direction (equivalent to the vehicle front-rear direction when mounted on the vehicle) and the width direction (equivalent to the vehicle left-right direction when mounted on the vehicle) of the seat cushion 21. A plurality of the recesses 24 are arranged in each of the depth direction and the width direction of the seat cushion 21 (which may be hereinafter referred to as a longitudinal direction and a lateral direction of the seat cushion 21). The recesses 24 are configured to be arranged in a grid pattern over the entire reinforcement range 23.

The inner surface of each recess 24 includes a cylindrical inner circumferential surface 24a and a planar bottom surface 24b that closes the upper end of the inner circumferential surface 24a. The reinforcement layer WB is formed on the surface layer including the inner circumferential surfaces 24a and the bottom surfaces 24b. Such a bottomed cylindrical reinforcement layer WB is configured to be arranged in a grid pattern over the entire reinforcement range 23. Accordingly, the entire reinforcement range 23 becomes a lump with increased strength and rigidity as compared to other portions which are formed of a urethane foam alone. With such a reinforcement range 23 present at the laterally central portion of the front portion of the seating position 21a in the seat cushion 21, it is easier to receive the body movement load of the occupant at the time of a vehicle front collision, and the submarine phenomenon can be suppressed.

As shown in FIG. 6, the bottom surface 24b of each recess 24 may be planar and inclined to be located higher on the front side of the molded product W. In that case, the bottom surface 24b of each recess 24 is arranged to be orthogonal to the body movement direction (indicated by arrow F in the figures) of the occupant when the occupant's body moves toward the vehicle front side while sinking into the seat cushion 21 at the time of a vehicle front collision. Accordingly, the reinforcement layer WB along the bottom surface 24b of each recess 24 contributes to reception of the load at the time of body movement of the occupant.

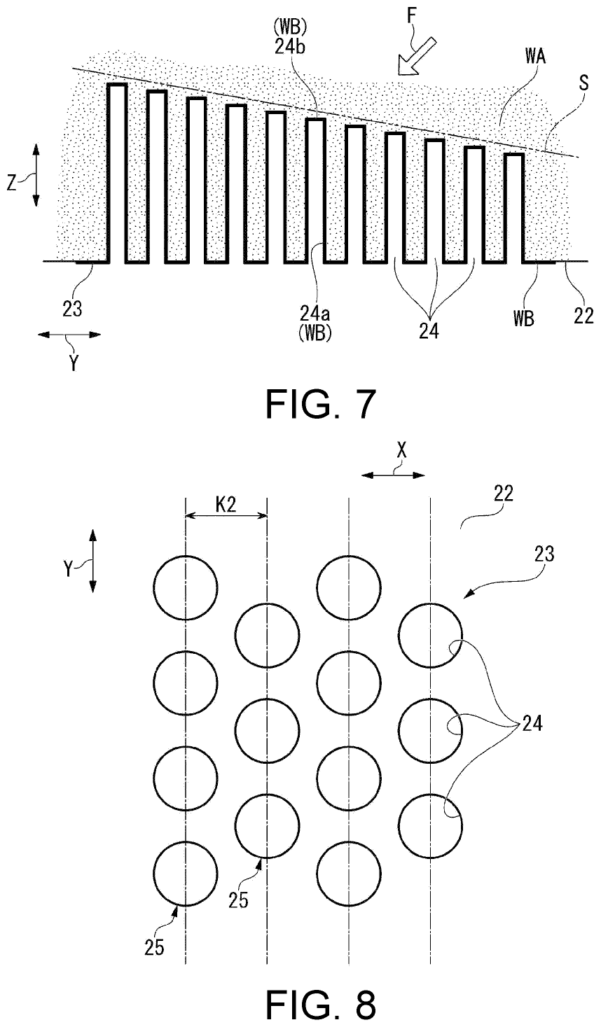

As shown in FIG. 7, the heights (depths) of the recesses 24 may be changed so that the bottom surface 24b of a recess 24 located on the front side of the molded product W is located higher. In that case, by arranging the bottom surfaces 24b of the recesses 24 to be located higher on the front side when mounted on the vehicle, a virtual surface S on which the bottom surfaces 24b are arranged is inclined to be located higher on the front side. That is, the virtual surface S is arranged to be orthogonal to the body movement direction of the occupant when the occupant's body moves toward the vehicle front side while sinking into the seat cushion 21 at the time of a vehicle front collision. Accordingly, the aggregate of the reinforcement layer WB with the recesses 24 contributes to reception of the load at the time of body movement of the occupant. In this case, although the bottom surface 24b of each recess 24 may be inclined as shown in FIG. 6, it may also be substantially horizontal as shown in FIG. 7 or may also have other shapes such as a round shape (not shown).

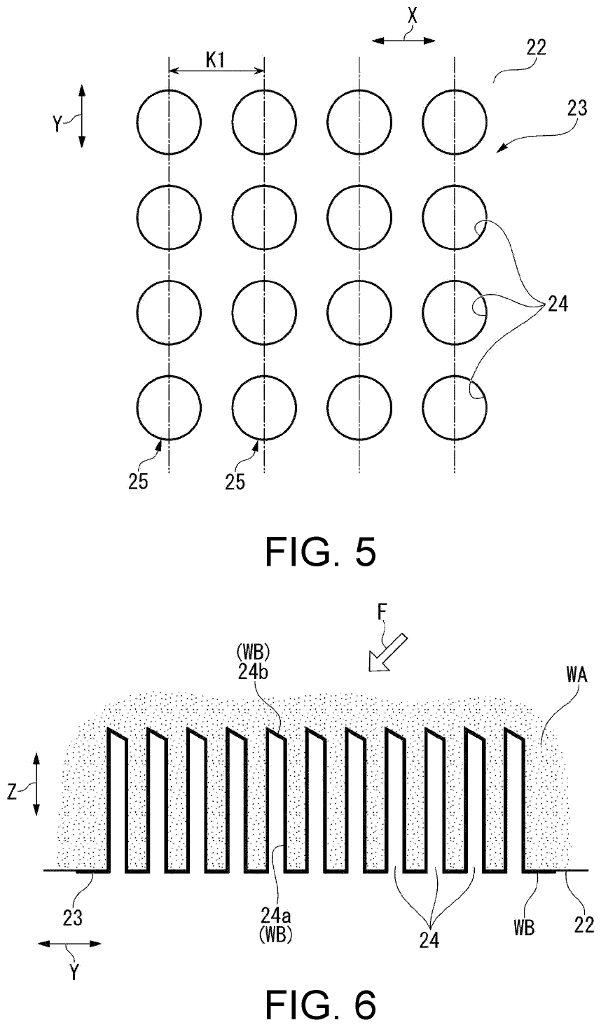

As shown in FIG. 5, a plurality of the recesses 24 are arranged in each of the depth direction and the width direction orthogonal to each other on the exterior surface 22 of the molded product W. Accordingly, the reinforcement layer WB along the inner surface of each recess 24 reinforces a rectangular range (surface) having a width in the longitudinal and lateral directions on the lower surface side of the seat cushion 21 and contributes to reception of the load at the time of body movement of the occupant.

In the example shown in FIG. 5, the recesses 24 are configured in a grid pattern by arranging along each of the depth direction and the width direction, but the disclosure is not limited to this configuration. For example, the recesses 24 may be configured in a twill pattern of arranging along a direction inclined with respect to each of the depth direction and the width direction.

Herein, among the recesses 24, a predetermined number of recesses 24 arranged at an equal interval with the depth direction of the molded product W as an arrangement direction form a recess column 25 extending in the depth direction. A plurality of recess columns 25 are provided in the reinforcement range 23. The recess columns 25 are provided to be arranged at an equal interval with the width direction of the molded product W as an array direction. In the example of FIG. 5, a pair of recess columns 25 adjacent to each other in the width direction are arranged so that the positions of the recesses 24 in the depth direction are aligned.

In the example of FIG. 8, a pair of recess columns 25 adjacent to each other in the width direction are arranged to shift with respect to each other in the depth direction. For example, the pair of recess columns 25 adjacent to each other in the width direction are arranged to shift by half a pitch (half pitch) between the recesses 24 in the depth direction (arrangement direction of the recesses 24). Accordingly, the recesses 24 of the recess columns 25 adjacent in the width direction may be brought closer to enter the valley between a pair of round hole-shaped recesses 24 arranged in the depth direction. Therefore, a pitch K2 of the recess columns 25 in FIG. 8 may be narrower than a pitch K1 of the recess columns 25 in FIG. 5. That is, it is possible to bring the recess columns 25 adjacent in the width direction as close as possible, and it is possible to arrange as many recess columns 25 (and thus recesses 24) as possible in the reinforcement range 23.

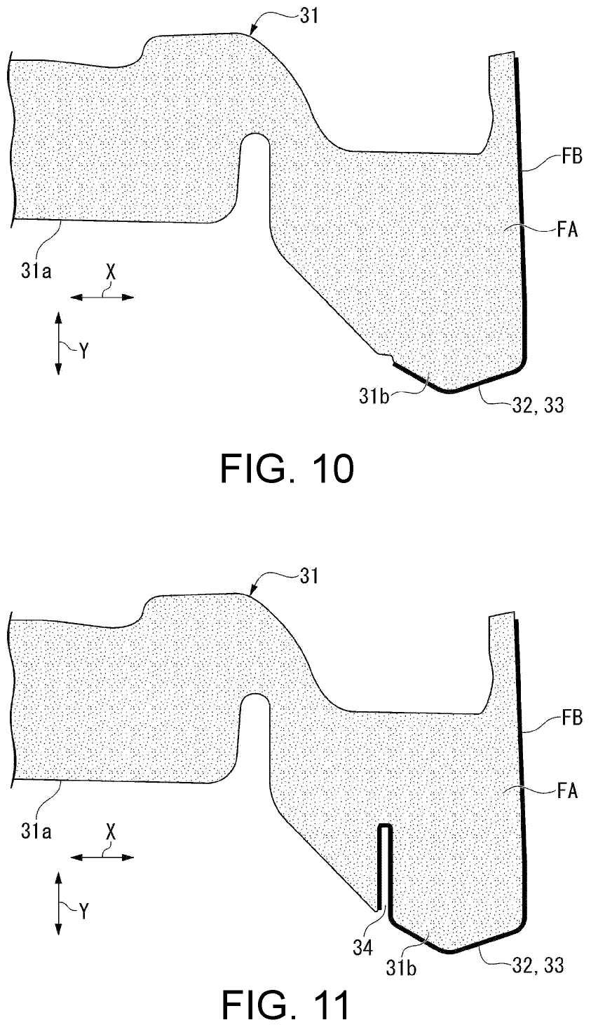

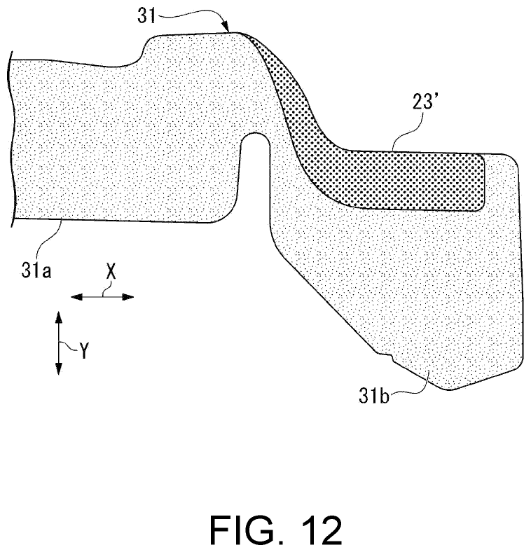

The molded product W shown in FIG. 9 and FIG. 10 is an example applied to the cushion member of the seat back 31 that supports the back of the occupant in the vehicle seat 20. In this example, a reinforcement range 33 with a reinforcement layer FB is set in a predetermined range of an exterior surface 32 along a backrest position (backrest surface; front surface) 31a of the seat back 31. The reinforcement range 33 is provided on the exterior surface 32 of a side support 31b that projects forward on the left and right sides of the backrest position 31a in the seat back 31. Accordingly, it is easier to receive the body movement load in the left-right direction of the occupant, and the support force at the time of a vehicle turn can be strengthened.

Different from the example of FIG. 10, the molded product W shown in FIG. 11 is an example in which the reinforcement range 33 of the side support 31b is formed with a recess 34 that is recessed backward from the exterior surface 32 of the side support 31b toward the inside (back surface side) of the molded product W. For example, the recess 34 of FIG. 11 has a bottomed round hole shape similar to the recess 24 of FIG. 3 to FIG. 8, and a plurality of the recesses 34 are arranged along the vertical direction of the backrest surface 31a. By forming the reinforcement layer FB (urethane impregnated cured layer FB on the surface of a urethane foam main body FA) also on the surface layer along the inner surface of the recess 34, the strength and rigidity of the reinforcement range 33 can be further increased. Also, a reinforcement range 33 similar to that of FIG. 9 to FIG. 11 may be provided on the seating surface 21a side of a side support 21b of the seat cushion 21. Further, a reinforcement range 23′ similar to the reinforcement range 23 of FIG. 1 to FIG. 8 may also be provided on the rear surface (back surface) side of the seat back 31 (see FIG. 12). Further, a reinforcement range 23′ similar to that in FIG. 12 may also be provided on the back surface (lower surface) side of the side support 21b of the seat cushion 21. Further, as a further example, the hardness of the urethane used for the side supports 31b and 21b outside the reinforcement range may be set to a hardness different from those of the backrest surface 31a and the seating surface 21a. Accordingly, it is possible to expand the range of realization for the comfort of the occupant as variously required depending on the seat position, the vehicle type, and the like.

<Molding Apparatus of Foam Molded Product>

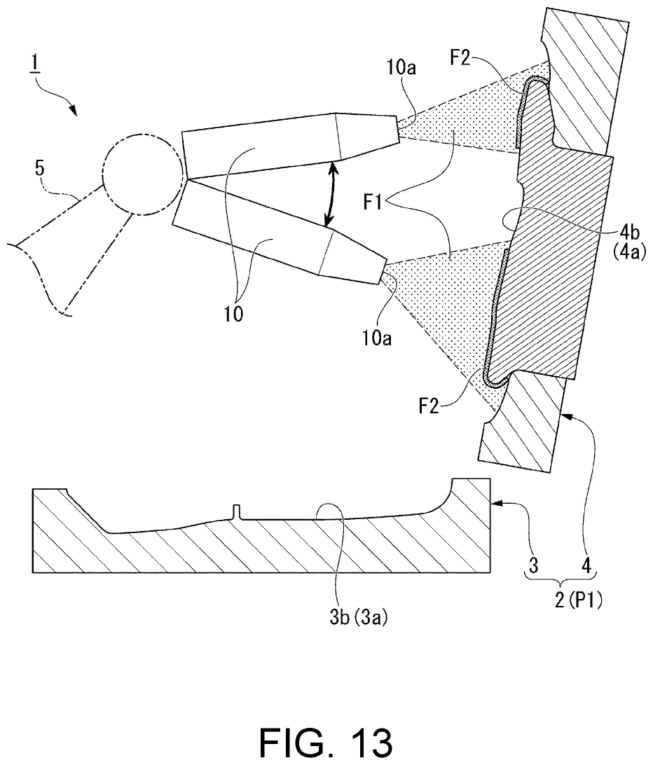

Next, a molding apparatus 1 for manufacturing the molded product W of the embodiment will be described. As schematically shown in FIG. 13, the molding apparatus 1 of the embodiment is, for example, a molding apparatus of a urethane pad which is a cushion member of the vehicle seat 20. The molded product W obtained by this molding apparatus 1 is a urethane integral foam molded product in which a urethane impregnated cured layer WB, which is a fiber reinforcement layer, is integrally formed on at least a part of the surface (surface layer) of a urethane foam main body WA. The urethane impregnated cured layer WB is locally harder than other portions including urethane alone, and is provided, for example, in portions in contact with other parts such as a seat frame, or portions particularly intended to support a load received from the occupant's body.

The molding apparatus 1 includes a mold (molding mold) 2 for molding the urethane foam main body WA and molding the urethane impregnated cured layer WB on the surface of the urethane foam main body WA. In the example of FIG. 13, a nozzle 10 for spraying a short fiber material (hereinafter simply referred to as a short fiber F1), which is a reinforcing material of the urethane impregnated cured layer WB, is provided on at least a part of the wall surface (cavity surface) facing a cavity 2C in the mold 2. The short fiber F1 is, for example, a cellulose fiber.

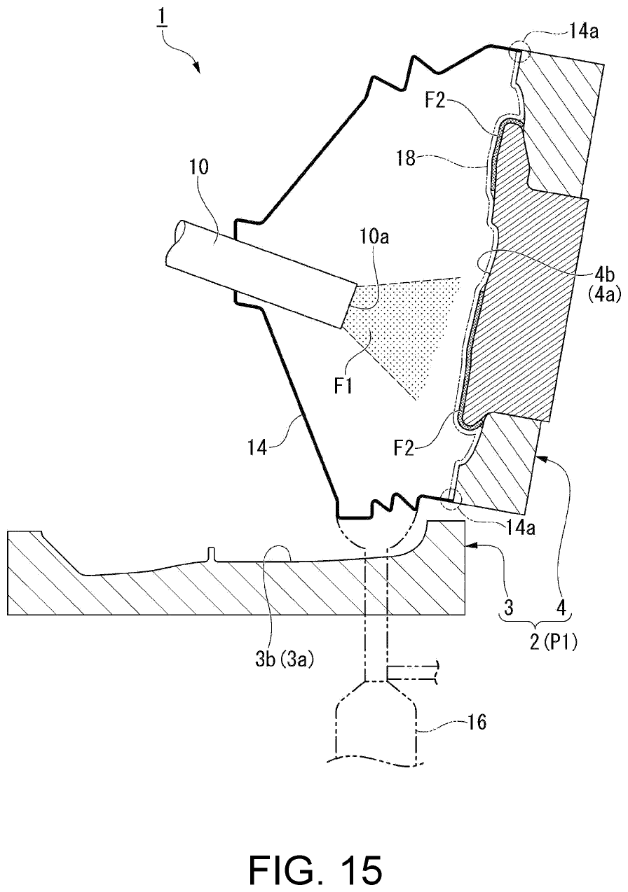

The mold 2 is movable between a spread state P1 shown in FIG. 13 and FIG. 15 and a mold clamping state P2 shown in FIG. 17. In the figures, numeral 3 indicates a fixed mold fixed to a fixed platen, and numeral 4 indicates a movable mold that is movable with respect to the fixed mold 3. The fixed mold 3 has a recess 3a recessed toward the fixed platen side. The wall surface (cavity surface) 3b of the recess 3a is a surface for forming the design surface of the molded product W.

The movable mold 4 is operated together with a movable platen by the operation of a displacement mechanism (e.g., a hydraulic cylinder or the like) (not shown) to approach and separate from the fixed mold 3. With the movable mold 4 approaching the fixed side, the mold 2 is closed (mold clamping). The movable mold 4 has an opposite part 4a that faces the recess 3a of the fixed mold 3 at the time of mold clamping. The recess 3a and the opposite part 4a form the cavity 2C inside the mold 2. A wall surface (cavity surface) 4b of the opposite part 4a is a surface for forming the back surface on the opposite side of the design surface of the molded product W.

With a large number of drilled holes, for example, the wall surface 4b of the movable mold 4 has air permeability allowing air to pass. The movable mold 4 may suck air into the movable mold 4 from the holes of the wall surface 4b by a negative pressure generator (not shown). By sucking air at the wall surface 4b of the movable mold 4, the short fiber F1 blown out from the nozzle 10 is adsorbed to the wall surface 4b, and a fiber layer F2 may be formed on the wall surface 4b.

The nozzle 10 has, for example, a cylindrical shape, and its axial base end side is held by a robot arm 5. The short fiber F1 which has been charged is supplied to the nozzle 10 together with carrier air. An axial tip part 10a of the nozzle 10 is provided with an outlet for blowing out the supplied short fiber F1.

By the operation of the robot arm 5, the nozzle 10 has the tip part 10a face a predetermined portion of the wall surface 4b of the movable mold 4 of the mold 2 in the spread state P1. The short fiber F1 is sprayed from the outlet of the tip part 10a of the nozzle 10 toward the wall surface 4b of the movable mold 4. By depositing the short fiber F1 on the wall surface 4b, a fiber layer F2 having a specified thickness is formed on the wall surface 4b of the movable mold 4. With the wall surface 4b of the movable mold 4 sucking air, the fiber layer F2 is adsorbed to the wall surface 4b.

When the formation of the fiber layer F2 on the wall surface 4b of the movable mold 4 is completed, various insert parts are set in the mold 2, and a urethane liquid is injected into the recess 3a of the fixed mold 3. Then, the movable mold 4 of the mold 2 in the spread state P1 is superposed on the fixed mold 3 and clamped, and the urethane liquid is heat-treated together with the mold 2. Accordingly, urethane is foamed and cured in the cavity 2C formed by the recess 3a of the fixed mold 3 and the wall surface 4b of the movable mold 4, and a molded product W having a specified shape is formed. The urethane liquid may also be injected into the cavity 2C after the mold 2 is clamped.

<Method of Manufacturing Foam Molded Product>

Next, a manufacturing method for manufacturing a foam molded product W in which a reinforcement layer (urethane impregnated cured layer) WB including a short fiber F1 is integrally formed on the surface of a urethane foam main body WA made of foam material will be described.

<Fiber Layer Formation Step>

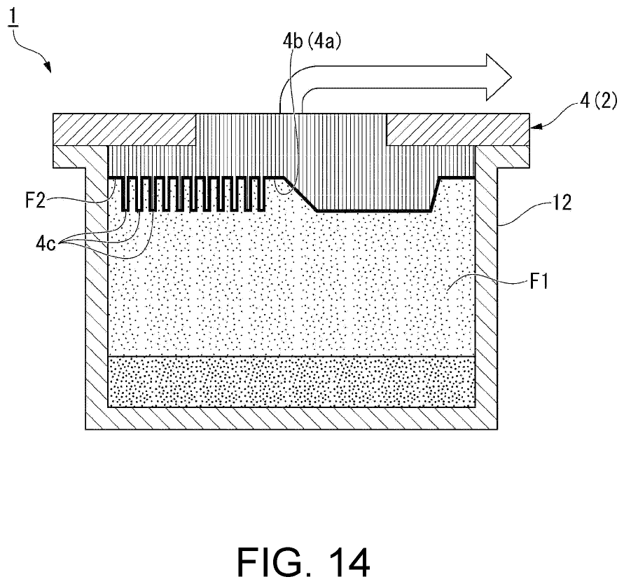

First, a fiber layer formation step of forming a fiber layer F2 is performed by depositing while adhering the short fiber F1 onto the cavity surface (wall surface 4b of the movable mold 4) of the mold 2. Referring to FIG. 14, as a first pattern of the fiber layer formation step, a box-shaped lower frame (frame body) 12 is attached to the mold 2 (movable mold 4) for operation. By blowing the short fiber F1 into the lower frame 12 and winding up, the short fiber F1 is adhered to the cavity surface 4b of the mold 2. The short fiber F1 is charged in a material supply apparatus by a method such as triboelectric charging. That is, there is a charging step of charging the short fiber F1 before or at the same time as the fiber layer formation step. The triboelectric charging refers to a method of winding up the short fiber F1 by blowing agitated air or the like into a container containing the short fiber F1 to charge the short fiber F1 by friction between the short fiber F1 and the container wall surface.

In the fiber layer formation step, the mold 2 is set to a spread state P1, and the lower frame 12 is attached to cover a specified portion of the wall surface 4b of the spread movable mold 4. In the example of FIG. 14, the lower frame 12 is attached with the wall surface 4b of the movable mold 4 facing downward. In addition, the fiber layer F2 may also be formed on the wall surface 3b of the fixed mold 3. The wall surface 4b of the movable mold 4 may be capable of negative pressure suction as described above, and the short fiber F1 in place of non-woven fabric is adsorbed by vacuum suction onto the wall surface 4b of the movable mold 4. The wall surface 4b is made of a non-metallic material and may adsorb the charged short fiber F1 without removing the charge. That is, the wall surface 4b of the mold 2 (movable mold 4) is a non-metal air-permeable region, and the charged short fiber F1 is adhered to this air-permeable region. By charging the supply material, the step of charging the wall surface 4b of the mold 2 becomes unnecessary, and the equipment and the step can be simplified.

In the embodiment, the charged short fiber F1 is supplied into the lower frame 12 with the suction of air started in the wall surface 4b. The short fiber F1 is adhered to and deposited on the wall surface 4b by static electricity and suction. Accordingly, a fiber layer F2 is formed at a specified portion of the wall surface 4b of the movable mold 4. The fiber layer F2 is formed as a layer having a constant specified thickness on at least a part of the wall surface 4b.

Referring to FIG. 15, as a second pattern of the adhesion step, the short fiber F1 is sprayed with the nozzle 10 toward the wall surface 4b of the mold 2 (movable mold 4), and the short fiber F1 is adhered to the wall surface 4b of the movable mold 4. In the second pattern, similarly, the short fiber F1 may be charged as in the first pattern. The wall surface 4b of the movable mold 4 may be capable of negative pressure suction, and the short fiber F1 blown out from the nozzle 10 is adhered to and deposited on the non-metal wall surface 4b of the movable mold 4 by the action of static electricity and suction.

In the second pattern, a cover member 14 in place of the lower frame 12 of the first pattern is attached to the mold 2 (movable mold 4). By blowing out the short fiber F1 in the cover member 14, it is possible to prevent the short fiber F1 from scattering around the mold 2. That is, before the fiber layer formation step, there is a cover attachment step of attaching the cover member 14 to the mold 2. The cover member 14 is made of a material (e.g., rubber sheet, cloth, etc.) that flexibly covers the periphery of the mold 2 (movable mold 4) in a manner that allows the nozzle 10 to be movable. If the cover member 14 is a material having air permeability, it may capture excessive raw material while allowing the air flow accompanying the blowout of the short fiber F1 to escape. Inside the cover member 14, a storage part 14a for storing a silicone rubber sheet 18 (to be described later) by winding or the like may be provided.

A suction device 16 for sucking the short fiber F1 floating in the space in the cover member 14 is connected to the cover member 14. The suction device 16 opens a suction port in the cover member 14 at the lower end of the cover member 14, and sucks and recovers the short fiber F1 together with the air flow in the cover member 14. The air suction amount at this time is equal to or less than the amount of air blown out from the nozzle 10. This configuration can prevent the short fiber F1 floating in the cover from unintentionally adhering to the wall surface 4b and the fiber layer F2, and can efficiently form the fiber layer F2 having uniform thickness and density in the predetermined range of the wall surface 4b. The short fiber F1 recovered in the suction device 16 is returned to the material supply device, and after being charged, is blown out again from the nozzle 10 toward the mold 2, so that the material cost can be suppressed.

<Covering Step>

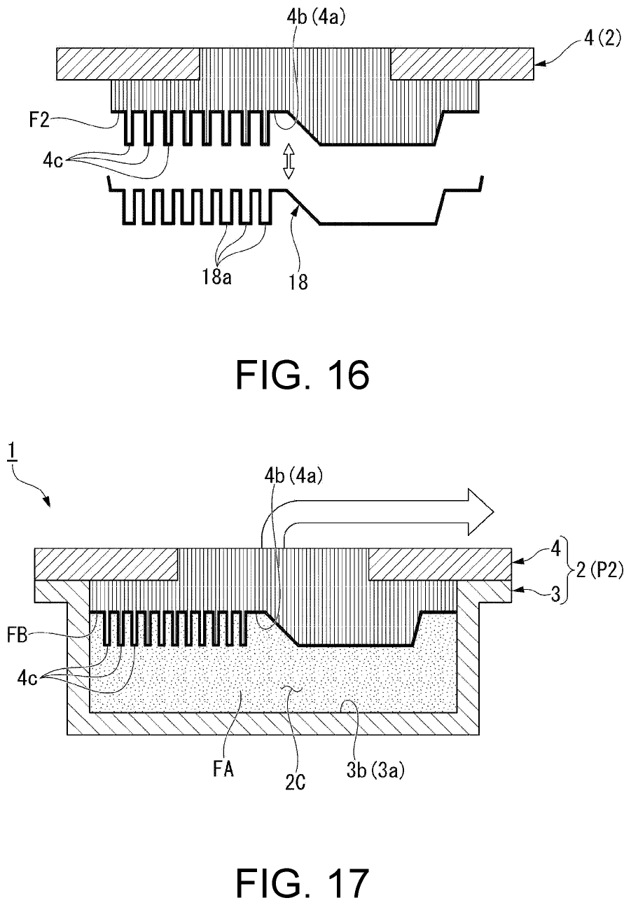

Referring to FIG. 15 and FIG. 16, after the fiber layer F2 is formed on the mold 2 in the fiber layer formation step, a covering step of arranging a covering material (bagging sheet) on the fiber layer F2 to cover the fiber layer F2 is performed. The covering material is made of a stretchable insulating material such as a silicone rubber sheet 18. The silicone rubber sheet 18 may cover the fiber layer F2 without breaking the fiber layer F2 deposited by utilizing static electricity. The silicone rubber sheet 18 secures a portion in airtight contact with the mold 2 outside the range where the fiber layer F2 is formed. Within the portion where the silicone rubber sheet 18 is in airtight contact with the mold 2, the fiber layer F2 may be compressed by a subsequent compression step.

The silicone rubber sheet 18 is made of a highly stretchable rubber material or the like, and in the subsequent compression step, it well follows the protrusions and recesses of the wall surface 4b of the mold 2 (see FIG. 15), and when the wall surface 4b of the mold 2 has a high protruding shape, a deep hole shape, or the like, it is desirable to form a shape similar to these shapes in advance (see FIG. 16). Referring to FIG. 16, in the embodiment, to form each recess 24 of the molded product W, the wall surface 4b of the mold 2 is provided with a plurality of columnar protruding parts 4c extending into the cavity 2C along the mold separation direction. The short fiber F1 also adheres to the outer surface of each of the protruding parts 4c to form the fiber layer F2. A covering profile 18a that covers each of the protruding parts 4c is formed in advance on the silicone rubber sheet 18.

In the region covered by the cover member 14, a storage part 14a for storing the silicone rubber sheet 18 so that it may be taken in and out is provided. Accordingly, after the fiber layer formation step, it is possible to cover the fiber layer F2 with the silicone rubber sheet 18 and remove the silicone rubber sheet 18 from the fiber layer F2 without removing the cover member 14, and it is possible to efficiently manufacture the foam molded product W.

<Compression Step>

Referring to FIG. 15, after mounting the silicone rubber sheet 18 on the mold 2 in the covering step, a compression step of compressing the fiber layer F2 between the silicone rubber sheet 18 and the cavity surface 4b is performed by vacuum-sucking the air between the silicone rubber sheet 18 and the cavity surface 4b. By compressing the fiber layer F2 deposited on the mold 2 with the silicone rubber sheet 18, the packing density of the short fiber F1 can be made uniform and the strength can be improved. By using an insulator instead of a conductor for compressing the fiber layer F2, it is possible to prevent removal and reduction of the static electricity of the short fiber F1.

By pressing the short fiber F1 against the wall surface 4b of the mold 2 by the compression of the fiber layer F2, the length direction of the short fiber F1 is aligned to be substantially parallel to the wall surface 4b of the mold 2. In the short fiber F1, the fibers tend to repel each other due to charging, and it may be difficult for the fiber density in the fiber layer F2 to be uniform. Also, in this case, by compressing the fiber layer F2 by bagging, the fiber density can be increased and made uniform.

By compressing the fiber layer F2 and making it uniform at a high density, when the fiber layer F2 is impregnated with the urethane liquid, it is difficult for the urethane liquid to reach from the fiber layer F2 to the mold surface side (difficult to exude). Therefore, the molded product W can be easily released, and the mold can be easily cleaned after the release. Further, when the reinforcement layer WB of the molded product W is in contact with other parts such as a seat frame, if the urethane foam adheres to the surface of the reinforcement layer WB, it may cause abnormal noise due to contact with other parts, but such a concern can be suppressed.

Here, in the seat cushion 21, from the viewpoint of sitting comfort and the like, it is important to improve the accuracy regarding the distribution of the short fiber F1 in the reinforcement layer WB. Since the charged short fiber F1 has a repulsive force due to charging, the amount of adhesion to the mold 2 may be uneven. When a resin material is injected in such a state, a phenomenon such as a partial difference in the strength of the seat cushion 21 may occur.

As an example of countermeasures against the above phenomenon, it is considered effective to arrange (align) the short fiber F1 along the wall surface 4b of the mold 2 after the short fiber F1 is adhered. However, when the alignment is performed by an air flow, it is difficult to make a precise adjustment to make the overall density uniform. In addition, when the alignment is performed with the mold 2, since the static electricity charged on the short fiber F1 is removed upon contact with the mold 2, when the mold 2 is released, the fiber layer F2 collapses and there is a possibility that the adhesion amount of the short fiber F1 may be uneven.

In the embodiment, the wall surface 4b of the mold 2 to which the short fiber F1 is adhered is not made of metal, and by compressing the fiber layer F2 by vacuum suction using an insulating sheet, the fiber density of the fiber layer F2 can be increased and made uniform, and it is possible to produce a seat cushion 21 having excellent quality.

<Molding Preparation Step>

After compressing the fiber layer F2 in the compression step, the silicone rubber sheet 18 is removed from the fiber layer F2 by taking out the silicone rubber sheet 18 (covering material removal step), and the fiber layer F2 is exposed in the cavity 2C. Further, the lower frame 12 or the cover member 14 is removed from the movable mold 4, and the movable mold 4 and the fixed mold 3 are clamped (mold clamping step). Further, a foam material is supplied (filled) into the cavity 2C of the mold 2 (supply step).

The supply step may include an impregnation step of impregnating the fiber layer F2 with the foam material. The step of impregnating the fiber layer F2 with the foam material may be performed when the foam material is foamed in a subsequent molding step. The mold clamping step and the supply step may be interchanged in sequence. In the mold clamping step, a position deviation of the fiber layer F2 may be prevented by continuing the suction of air at the wall surface 4b. The covering material removal step, the mold clamping step, and the supply step are collectively referred to as a molding preparation step.

<Molding Step>

After the molding preparation step, the foam material is foamed and cured in the cavity 2C to obtain a foam molded product W in which the reinforcement layer WB is integrally formed on the surface layer (molding step). The fiber layer F2 held on the wall surface 4b is integrally formed as the surface layer of the molded product W by impregnating the urethane liquid in the cavity 2C and then performing a heat treatment at the time of urethane molding. The fiber layer F2 is cured at the time of urethane foam molding to form a urethane impregnated cured layer WB which is locally harder than other portions of urethane alone. That is, by forming the fiber layer F2 in advance at the specified portion of the wall surface 4b, it is possible to form the urethane impregnated cured layer WB having a hardness higher than that of other portions.

As described above, the method of manufacturing a molded product in the above embodiment is a method of manufacturing a foam molded product W having a reinforcement layer WB including a short fiber F1 provided on a surface layer. The method includes the following steps. In a fiber layer formation step, the short fiber F1 is adhered to and deposited on a cavity surface 4b of a mold 2 to form a fiber layer F2. In a covering step, a silicone rubber sheet 18 is arranged on the mold 2 to cover the fiber layer F2. In a compression step, air is sucked between the silicone rubber sheet 18 and the cavity surface 4b to compress the fiber layer F2 by the silicone rubber sheet 18 and the cavity surface 4b. In a molding preparation step, the silicone rubber sheet 18 is removed from the fiber layer F2 after compression, a foam material is suppled into a cavity 2C of the mold 2, and the mold 2 is clamped. In a molding step, the foam material in the cavity 2C is foamed and cured to obtain a foam molded product W.

According to this configuration, by compressing the fiber layer F2 formed on the cavity surface 4b with the silicone rubber sheet 18, the strength of the fiber layer F2 can be improved. Accordingly, it is possible to prevent the short fiber F1 from partially falling off and to facilitate uniformity of the material density and the thickness of the fiber layer F2. In addition, since the compressed fiber layer F2 makes it difficult for the foam material to reach the cavity surface 4b, it is easier to release the foam molded product W and clean the mold, and the foam molded product W can be efficiently manufactured. Further, the reinforcement layer WB is provided at a portion in contact with other parts such as a seat frame, and if the foam material exudes to the reinforcement layer WB, the foam body may come into contact with other parts and abnormal noise may be generated. In contrast, by making the material density and the thickness of the fiber layer F2 uniform, it is possible to suppress generation of abnormal noise.

The method of manufacturing a molded product includes a charging step of charging the short fiber F1 before or at the same time as the fiber layer formation step. The fiber layer formation step is a step of adhering and depositing the charged short fiber F1 onto a non-metal portion on the cavity surface 4b. In the covering step, the fiber layer F2 is covered with the silicone rubber sheet 18 composed of an insulator. According to this configuration, by adhering the charged short fiber F1 to the non-metal portion of the cavity surface 4b, the fiber layer F2 can be easily formed by utilizing static electricity. Further, by charging the short fiber F1 and using the charged short fiber F1, it is possible to eliminate the need for large-scale equipment and steps such as one for charging the mold 2. Further, by using an insulator for the silicone rubber sheet 18 that covers the fiber layer F2, it is possible to suppress removal of the static electricity of the short fiber F1 and collapse of the fiber layer F2.

In the method of manufacturing a molded product, the cavity surface 4b has air permeability allowing air to pass. In the fiber layer formation step, by sucking air at the cavity surface 4b, the short fiber F1 is adsorbed to the cavity surface 4b. According to this configuration, by adsorbing the short fiber F1 while performing air suction at the cavity surface 4b, the fiber layer F2 on the cavity surface 4b can be formed more quickly, and the foam molded product W can be manufactured more efficiently.

In the method of manufacturing a molded product, in the covering step, by sucking air at the cavity surface 4b, the short fiber F1 is adsorbed to the cavity surface 4b. According to this configuration, it is possible to prevent the short fiber F1 from falling off from the cavity surface 4b up to the time when the fiber layer F2 is compressed by the silicone rubber sheet 18. Accordingly, the material density and the thickness of the fiber layer F2 can be made uniform.

In the method of manufacturing a molded product, in the compression step, by sucking air at the cavity surface 4b, the fiber layer F2 is compressed by the silicone rubber sheet 18 and the cavity surface 4b. According to this configuration, the fiber layer F2 can be compressed by the silicone rubber sheet 18 while the fiber layer F2 is adsorbed to the cavity surface 4b. Accordingly, the foam molded product W can be manufactured more efficiently.

In the method of manufacturing a molded product, the fiber layer formation step is a step of blowing out the short fiber F1 from a nozzle 10 to form the fiber layer F2 on the cavity surface 4b, and the method includes, before the fiber layer formation step, a cover attachment step of covering the cavity surface 4b with a cover member 14 by leaving a blowout space facing an outlet of the nozzle 10. According to this configuration, the fiber layer F2 is formed by spraying the short fiber F1 from the nozzle 10 onto the cavity surface 4b, so that the fiber layer F2 can be formed quickly and efficiently. Further, by covering the cavity surface 4b with the cover member 14 by leaving a blowout space facing the outlet of the nozzle 10, in the subsequent fiber layer formation step, even if a part of the short fiber F1 does not adhere to the cavity surface 4b, it is possible to prevent the short fiber F1 from scattering around the mold 2.

In the method of manufacturing a molded product, in the fiber layer formation step, the short fiber F1 floating in the blowout space is sucked by a suction device 16. According to this configuration, by sucking and removing the excessive short fiber F1 floating in the cover member 14, the uniformity of the fiber layer F2 can be improved. Further, the excessive short fiber F1 that does not adhere to the cavity surface 4b may be recovered and reused, so that the material cost can be suppressed and the economic efficiency can be improved.

In the method of manufacturing a molded product, a region covered with the cover member 14 is provided with a storage part 14a storing the silicone rubber sheet 18 so that the silicone rubber sheet 18 may be taken in and out. According to this configuration, after the fiber layer formation step, the fiber layer F2 can be covered with the silicone rubber sheet 18 without removing the cover member 14. Therefore, as compared with the case where the silicone rubber sheet 18 is arranged after removing the cover member 14 after the fiber layer formation step, it is possible to quickly perform the steps from the formation of the fiber layer F2 to the compression of the fiber layer F2. Accordingly, the foam molded product W can be manufactured more efficiently.

Further, the molded product structure in the above embodiment is a structure of a foam molded product W having a reinforcement layer WB including a short fiber F1 provided on a surface layer. The foam molded product W is a cushion member of at least one of a seat cushion 21 on which an occupant sits in a vehicle seat 20 and a seat back 31 that supports a back of the occupant. A reinforcement range 23 and 33 with the reinforcement layer WB is set in a predetermined range of an exterior surface 22 and 32 along at least one of a seating surface 21a and a lower surface of the seat cushion 21, and a backrest surface 31a and a back surface of the seat back 31. In the reinforcement range 23 and 33, a recess 24 and 34 recessed from the exterior surface 22 and 32 toward inside of the foam molded product W is formed, and the reinforcement layer WB is formed on the surface layer including an inner surface of the recess 24 and 34.

According to this configuration, by forming the reinforcement layer WB on the surface layer including the inner surface of the recess 24 and 34 in the reinforcement range 23 and 33 of the foam molded product W, the hardness of the cushion member of the vehicle seat 20 can be locally increased. Accordingly, it is possible to well support and restrain the body of the seated person on whom acceleration acts due to acceleration/deceleration or turning of the vehicle. Further, by forming the recess 24 and 34 in the reinforcement range 23 and 33, the material cost is reduced for the recess 24 and 34, and by integrally molding the reinforcement layer WB with the cushion member, separate insert parts and their fasteners are not required. Therefore, the weight of the cushion member can be reduced and the cost can be reduced, and the foam molded product W can be manufactured more efficiently.

In the molded product structure, a plurality of the recesses 24 and 34 are formed in the reinforcement range 23 and 33. According to this configuration, by forming a plurality of the recesses 24 and 34 having the reinforcement layer WB formed on the inner surface, reinforcement suitable for the size and required strength of the reinforcement range 23 and 33 can be performed. In the seat cushion 21, since the recesses 24 are arranged in a grid pattern along the vehicle front-rear direction and the vehicle left-right direction, it is possible to efficiently disperse the load at the time of movement of the seated person due to acceleration/deceleration or turning to the recesses 24 and the reinforcement layer WB, and the occupant's body can be well supported and restrained.

In the molded product structure, the foam molded product W is a cushion member of the seat cushion 21, and the reinforcement range 23 is set on the exterior surface 22 along the lower surface of the seat cushion 21. Each of the recesses 24 is recessed upward from the exterior surface 22 toward a seating surface 21a side of the seat cushion 21 and includes a bottom surface 24b at an upper end. The reinforcement layer WB is formed on the surface layer including the bottom surface 24b, and the bottom surface 24b is planar and inclined to be located higher on a front side of the seat cushion 21 when mounted on a vehicle. According to this configuration, by inclining each planar bottom surface 24b (upper end) to be located higher on the front side when mounted on a vehicle, it is easier to suppress the so-called submarine phenomenon. That is, to address the submarine phenomenon in which the occupant's body moves toward the vehicle front side while sinking into the seat cushion 21 at the time of a vehicle front collision, each planar bottom surface 24b is inclined to be perpendicular to the body movement direction of the occupant. Accordingly, the reinforcement layer WB along the inner surface of each recess 24 contributes to reception of the load at the time of body movement of the occupant, and the submarine phenomenon can be easily suppressed.

In the molded product structure, the foam molded product W is a cushion member of the seat cushion 21, and the reinforcement range 23 is set on the exterior surface 22 along the lower surface of the seat cushion 21. Each of the recesses 24 is recessed upward from the exterior surface 22 toward a seating surface 21a side of the seat cushion 21, and includes a bottom surface 24b at an upper end. The reinforcement layer WB is formed on the surface layer including the bottom surface 24b, and the recesses 24 are arranged so that the bottom surface 24b located on a front side of the seat cushion 21 when mounted on a vehicle is located higher. According to this configuration, by arranging the bottom surfaces 24b of the recesses 24 to be located higher on the front side when mounted on a vehicle, it is easier to suppress the so-called submarine phenomenon. That is, by gathering the bottom surfaces 24b of the recesses 24, a virtual surface S inclined to be located higher on the front side when mounted on a vehicle is formed. To address the submarine phenomenon in which the occupant's body moves toward the vehicle front side while sinking into the seat cushion 21 at the time of a vehicle front collision, the virtual surface S is inclined to be perpendicular to the body movement direction of the occupant. Accordingly, the aggregate of the reinforcement layer WB with the recesses 24 contributes to reception of the load at the time of body movement of the occupant, and the submarine phenomenon can be easily suppressed.

In the above molded product structure, a plurality of the recesses 24 are configured to be arranged in each of a first direction (depth direction) and a second direction (width direction) orthogonal to each other on the exterior surface 22. According to this configuration, by configuring a plurality of the reinforcement layers WB along the inner surface of each recess 24 to be arranged in two directions such as the longitudinal and lateral directions (in a grid pattern) on the lower surface side of the seat cushion 21, it is easier to receive the load at the time of body movement of the occupant in a range (surface) having a width in the longitudinal and lateral directions on the lower surface side of the seat cushion 21 (it is easier to stably support and restrain the occupant's body). Accordingly, it is possible to easily suppress the submarine phenomenon in which the occupant's body moves toward the vehicle front side while sinking into the seat cushion 21 at the time of a vehicle front collision. The arrangement direction of the recesses 24 may be a twill pattern that is inclined with respect to the longitudinal and lateral directions of the exterior surface 22.

In the molded product structure, the recesses 24 form a plurality of recess columns 25 arranged in parallel with each other. Each of the recess columns 25 is formed so that the recesses 24 of each recess column 25 are arranged at an interval with one of the first direction and the second direction as an arrangement direction. A pair of the recess columns 25 that are adjacent to each other in another of the first direction and the second direction are arranged to shift with respect to each other in a range of the interval in the arrangement direction of the recesses 24. According to this configuration, by shifting the adjacent recess columns 25 by about half a pitch in the arrangement direction of the recesses 24, the adjacent recess columns 25 can be brought close to each other as much as possible in the array direction. Accordingly, it is possible to arrange the recess columns 25 and thus the recesses 24 in a larger number in the reinforcement range 23 (arranging the recesses 24 more densely), and the strength and rigidity of the reinforcement range 23 can be further increased.

Further, the method of manufacturing a molded product in the above embodiment is a method of manufacturing a foam molded product W having a reinforcement layer WB including a short fiber F1 provided on a surface layer. The foam molded product W is a cushion member of at least one of a seat cushion 21 on which an occupant sits in a vehicle seat 20 and a seat back 31 that supports a back of the occupant. A reinforcement range 23 and 33 with the reinforcement layer WB is set in a predetermined range of an exterior surface 22 and 32 along at least one of a seating surface 21a and a lower surface of the seat cushion 21, and a backrest surface 31a and a back surface of the seat back 31. In the reinforcement range 23 and 33, a recess 24 and 34 recessed from the exterior surface 22 and 32 toward inside of the foam molded product W is formed, and the reinforcement layer WB is formed on the surface layer including an inner surface of the recess 24 and 34. Referring to the example in which the foam molded product W is applied to a cushion member of the seat cushion 21, the manufacturing method includes the following steps. In a fiber layer formation step, the short fiber F1 is adhered to and deposited on a cavity surface 4b provided with a protruding part 4c for forming the recess 24 in a mold 2 to form a fiber layer F2. In a covering step, a silicone rubber sheet 18 on which a covering profile 18a corresponding to the protruding part 4c is formed is arranged on the mold 2 to cover the fiber layer F2. In a compression step, air between the silicone rubber sheet 18 and the cavity surface 4b is sucked to compress the fiber layer F2 by the silicone rubber sheet 18 and the cavity surface 4b. In a molding preparation step, the silicone rubber sheet 18 is removed from the fiber layer F2 after compression, a foam material is supplied into a cavity 2C of the mold 2, and the mold 2 is clamped. In a molding step, the foam material is foamed and cured in the cavity 2C to obtain the foam molded product W.

According to this configuration, by compressing the fiber layer F2 formed on the cavity surface 4b with the silicone rubber sheet 18, the strength of the fiber layer F2 can be improved. Accordingly, it is possible to prevent the short fiber F1 from partially falling off and to facilitate uniformity of the material density and the thickness of the fiber layer F2. In a configuration in which the recess 24 is provided in the reinforcement range 23 and the hardness of the cushion member is increased, by covering the protruding part 4c for forming the recess 24 with the covering profile 18a formed in advance on the silicone rubber sheet 18, the fiber layer F2 formed on the surface of the protruding part 4c can also be compressed to improve the strength of the fiber layer F2, and the reinforcement range 23 can be further reinforced.

The disclosure is not limited to the above embodiment. For example, although the embodiment has shown an example of application to a urethane foam and its molding apparatus (and a manufacturing method), the embodiment is not limited to the configuration related to the urethane foam (and the foam molded product), but may also be applied to configurations related to various molded products such as a fiber aggregate formed by laminating a synthetic fiber. Also, as long as the short fiber is air-conveyed, its material and size (length and thickness) may vary. Further, it may be applied to a foam molded product having a reinforcement layer using not only a fiber material but also a particle-shaped or powder-shaped raw material. Although the silicone rubber sheet has been exemplified as the covering material covering the material layer, the disclosure is not limited thereto. Any type of rubber may be used as long as it has insulating properties and has excellent stretchability like rubber. For example, examples other than silicone rubber include fluororubber, urethane rubber, NR (natural rubber), and the like. The configuration in the above embodiment is an example of the disclosure, and various modifications (e.g., replacing the components of the embodiment with other known components) may be made without departing from the gist of the disclosure.

What is claimed is:

1. A method of manufacturing a molded product, which is a method of manufacturing a molded product having a reinforcement layer comprising a reinforcing material provided on a surface layer, the method comprising:
a material layer formation step of adhering and depositing the reinforcing material onto a cavity surface of a mold to form a material layer;
a covering step of arranging a covering material on the mold to cover the material layer;
a compression step of sucking air between the covering material and the cavity surface to compress the material layer by the covering material and the cavity surface;
a molding preparation step of removing the covering material from the material layer after compression, supplying a molding material into a cavity of the mold, and clamping the mold; and
a molding step of curing the molding material in the cavity to obtain the molded product.

2. The method of manufacturing a molded product according to claim 1, further comprising a charging step of charging the reinforcing material before or at the same time as the material layer formation step, wherein
the material layer formation step is a step of adhering and depositing the charged reinforcing material onto a non-metal portion on the cavity surface, and
in the covering step, the material layer is covered with the covering material composed of an insulator.

3. The method of manufacturing a molded product according to claim 1, wherein
the cavity surface has air permeability allowing air to pass, and
in the material layer formation step, by sucking air at the cavity surface, the reinforcing material is adsorbed to the cavity surface.

4. The method of manufacturing a molded product according to claim 2, wherein
the cavity surface has air permeability allowing air to pass, and
in the material layer formation step, by sucking air at the cavity surface, the reinforcing material is adsorbed to the cavity surface.

5. The method of manufacturing a molded product according to claim 3, wherein in the covering step, by sucking air at the cavity surface, the reinforcing material is adsorbed to the cavity surface.

6. The method of manufacturing a molded product according to claim 3, wherein in the compression step, by sucking air at the cavity surface, the material layer is compressed by the covering material and the cavity surface.

7. The method of manufacturing a molded product according to claim 5, wherein in the compression step, by sucking air at the cavity surface, the material layer is compressed by the covering material and the cavity surface.

8. The method of manufacturing a molded product according to claim 1, wherein
the material layer formation step is a step of blowing out the reinforcing material from a nozzle to form the material layer on the cavity surface, and
the method further comprises, before the material layer formation step, a cover attachment step of covering the cavity surface with a cover member by leaving a blowout space facing an outlet of the nozzle.

9. The method of manufacturing a molded product according to claim 2, wherein
the material layer formation step is a step of blowing out the reinforcing material from a nozzle to form the material layer on the cavity surface, and
the method further comprises, before the material layer formation step, a cover attachment step of covering the cavity surface with a cover member by leaving a blowout space facing an outlet of the nozzle.

10. The method of manufacturing a molded product according to claim 3, wherein
the material layer formation step is a step of blowing out the reinforcing material from a nozzle to form the material layer on the cavity surface, and
the method further comprises, before the material layer formation step, a cover attachment step of covering the cavity surface with a cover member by leaving a blowout space facing an outlet of the nozzle.

11. The method of manufacturing a molded product according to claim 5, wherein
the material layer formation step is a step of blowing out the reinforcing material from a nozzle to form the material layer on the cavity surface, and
the method further comprises, before the material layer formation step, a cover attachment step of covering the cavity surface with a cover member by leaving a blowout space facing an outlet of the nozzle.

12. The method of manufacturing a molded product according to claim 6, wherein
the material layer formation step is a step of blowing out the reinforcing material from a nozzle to form the material layer on the cavity surface, and
the method further comprises, before the material layer formation step, a cover attachment step of covering the cavity surface with a cover member by leaving a blowout space facing an outlet of the nozzle.

13. The method of manufacturing a molded product according to claim 8, wherein in the material layer formation step, the reinforcing material floating in the blowout space is sucked by a suction means.

14. The method of manufacturing a molded product according to claim 8, wherein a region covered with the cover member is provided with a storage means storing the covering material in a manner capable of taking the covering material in and out.

15. The method of manufacturing a molded product according to claim 13, wherein a region covered with the cover member is provided with a storage means storing the covering material in a manner capable of taking the covering material in and out.
